(19) United States
(12) Patent Application Publication
(10) Pub. No.: US 2013/0334899 A1
(43) Pub. Date: Dec. 19, 2013

(54) ELECTRICAL GENERATION SYSTEMS AND METHODS

(71) Applicant: Benjamin Francis John Hallgren, West Ryde (AU)

(72) Inventor: Susan Motisse, Burleigh Heads (AU)

(21) Appl. No.: 13/971,888

(22) Filed: Aug. 21, 2013

Related U.S. Application Data
(63) Continuation-in-part of application No. 13/244,484, filed on Sep. 25, 2011.

(51) Int. Cl. H02K 44/00

(52) U.S. Cl. CPC H02K 44/00
USPC 310/11

(57) ABSTRACT

An apparatus and method for generating electricity are disclosed. A ferroliquid having magnetic dipoles is confined in a conduit which is endless and can have a spiral configuration. The conduit has an electric coil wrapped around it. A temperature difference and a first magnetic field are applied to the liquid, thereby both moving and aligning the dipoles of the ferroliquid. The aligned dipoles create a second magnetic field which interacts with the coil to generate an emf therein.

### BACKGROUND OF THE INVENTION

The present invention relates to the generation of electricity and, in particular, by the conversion of thermal energy into electrical energy making use of a liquid which includes particles having a magnetic dipole.

Over the years many proposals have been put forward to provide electric generators of various kinds. The following patents are representative of this art, namely U.S. Pat. Nos. 4,064,409, 5,632,093, 6,489,694, 6,504,271, 6,628,017, 6,982,501, 7,061,129, 7,095,143, 7,105,935 and 7,745,962.

There is a need for improved methods and apparatuses for generating electricity that overcome deficiencies of the prior art.

### SUMMARY OF THE INVENTION

In accordance with a first aspect of the present invention there is disclosed a method of generating electricity, said method comprising the steps of: confining a liquid including particles having a magnetic dipole to a conduit formed into an endless loop, winding a coil around at least a portion of said conduit, exposing said conduit to a temperature difference to establish a convective flow in said liquid through said conduit, and exposing said liquid to a first magnetic field to align said particles whilst within said magnetic field, wherein a second magnetic field produced by said aligned dipoles moves relative to said coil to thereby generate an electromotive force (hereafter “emf”) therein.

In accordance with a second aspect of the present invention there is disclosed an apparatus for generating electricity, said apparatus comprising a conduit formed into an endless loop and confining a liquid including particles having a magnetic dipole, a coil wound around at least a portion of said conduit, heat transfer means connected with said conduit to establish a temperature difference in said conduit which establishes a convective flow in said liquid through said conduit, and a pair of magnetic poles between which extends a first magnetic field to which said liquid is exposed to align said particles whilst within said magnetic field, whereby a second magnetic field produced by said aligned dipoles moves relative to said coil to thereby generate an emf therein.

### BRIEF DESCRIPTION OF THE DRAWINGS

The present invention will hereinafter be described in conjunction with the appended drawing figures wherein like numerals denote like elements.

FIG. 1 is a perspective view of a generator apparatus in accordance with an embodiment of the present invention;

FIG. 2 is a cross-sectional view taken along the line II-II of FIG. 1 and showing a first form of a conduit;

FIG. 3 is a cross-sectional view taken along the line III-III of FIG. 1 and showing a second form of a conduit;

FIG. 4 is a perspective view illustrating the winding of a coil around a conduit in accordance with an embodiment of the present invention;

FIG. 5 is a cross-sectional view through the upper portion of the generator of FIG. 1 taken along the line IV-IV of FIG. 1;

FIG. 6 is a perspective view of the generator of FIG. 1 showing an arrangement of permanent magnets in accordance with an embodiment of the present invention;

FIG. 7 is a circuit diagram illustrating the electrical connection of the coil of FIG. 1;

FIG. 8 is a cross-sectional view of the conduit of FIG. 9 taken along the line V-V of FIG. 9 illustrating an alternative arrangement for a conduit including thermally conductive portions in accordance with an embodiment of the present invention;

FIG. 9 is a perspective view of the conduit illustrated in FIG. 8;

FIG. 10 is a perspective view of a generator in accordance with another embodiment of the present invention;

FIG. 11 is a perspective view illustrating another alternative arrangement for a conduit in accordance with another embodiment of the present invention;

FIG. 12 is a perspective view of a generator in accordance with another embodiment of the present invention;

FIG. 13 is a cross-sectional view of the generator of FIG. 12 taken along the line VI-VI of FIG. 12;

FIG. 14 is a cross-sectional view similar to FIG. 13 but of a generator in accordance with another embodiment of the present invention;

FIG. 15 is a plan view of a generator in accordance with another embodiment of the present invention;

FIG. 16 is a perspective view of the generator of FIG. 15;

FIG. 17 is a perspective view of a generator incorporating a gnomic spiral in accordance with another embodiment of the present invention;

FIG. 18 is drawing of a gnomic spiral of the type utilized in the generator of FIG. 17;

FIG. 19 illustrates a mathematical formula for a gnomic surface; and

FIG. 20 is a perspective view of a generator in accordance with another embodiment of the present invention.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention, as set forth in the appended claims. In addition, reference numerals that are introduced in the specification in association with a drawing figure may be repeated in one or more subsequent figures without additional description in the specification in order to provide context for other features.

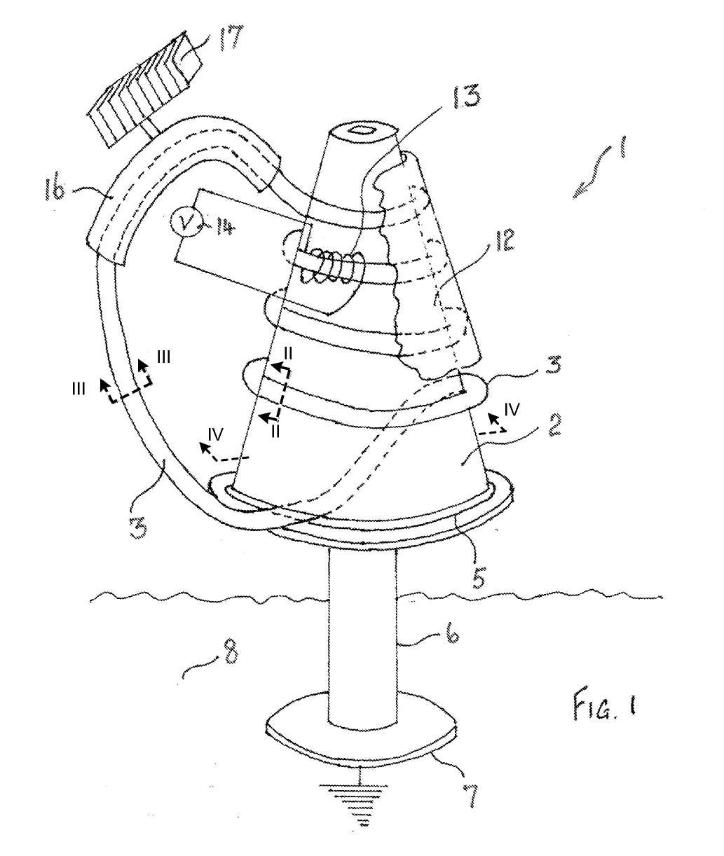

As seen in FIG. 1, a generator 1 takes the form of a cone shaped thermal conductor 2. Wrapped around the cone shaped thermal conductor 2 is a conduit 3 which is non-conducting and which is configured into a conical spiral as illustrated.

The cone shaped thermal conductor 2 is supported by a thermally conductive disc 5 which is supported by a thermally conductive stem 6 which terminates in a thermally conductive plate 7 that is in thermal communication with earth 8 (or a different heat sink).

Located exterior of the conduit 3 is a second cone shaped thermal conductor 12 which is only shown in fragmentary form in FIG. 1. Intermediate the conductors 2, 12 the conduit 3 has a coil 13 formed from insulated electrical wire which is wrapped around the conduit 3. The coil 13 can be spiral, helical, solenoidal or helicoidal. The coil 13 is connected to a volt meter 14.

In addition, the conduit 3 passes through a thermally conductive sleeve 16 which is thermally connected to a heat exchanger 17. The heat exchanger is exposed to solar radiation (or some other heat source such as industrial waste heat, a geothermal heat source, or the like).

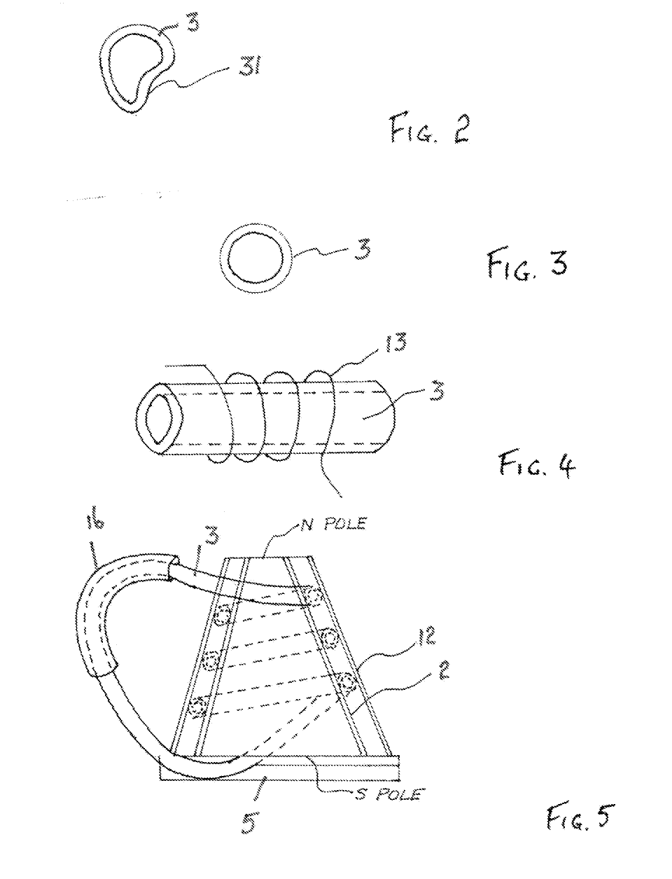

As seen in FIG. 2, the conduit 3 preferably has a flattened surface 31 which lies against the interior cone shaped thermal conductor 2 thereby increasing the thermal transfer without impeding flow of liquid through the conduit 3.

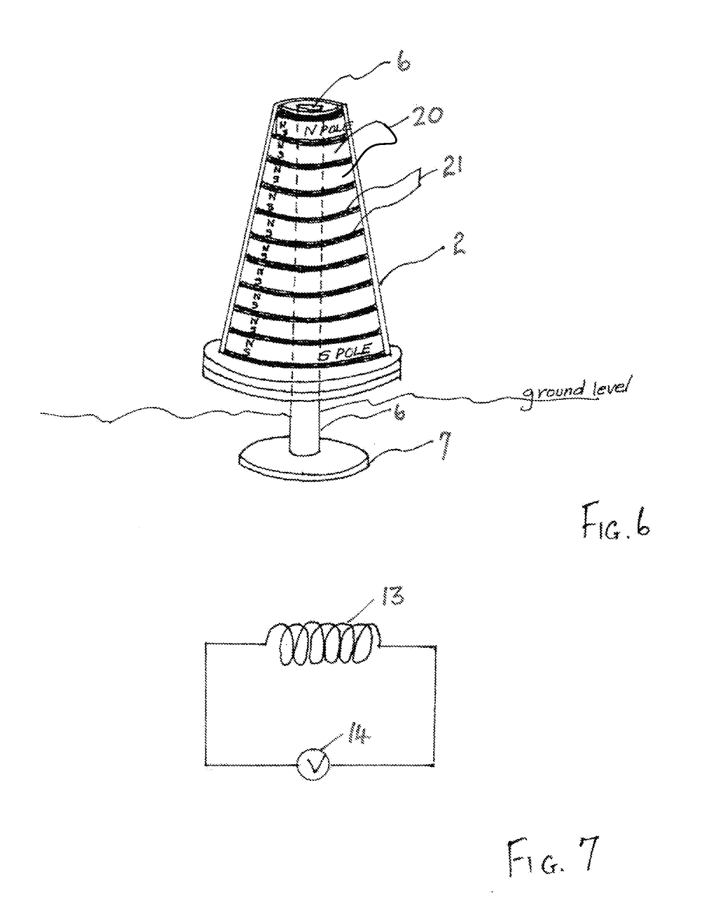

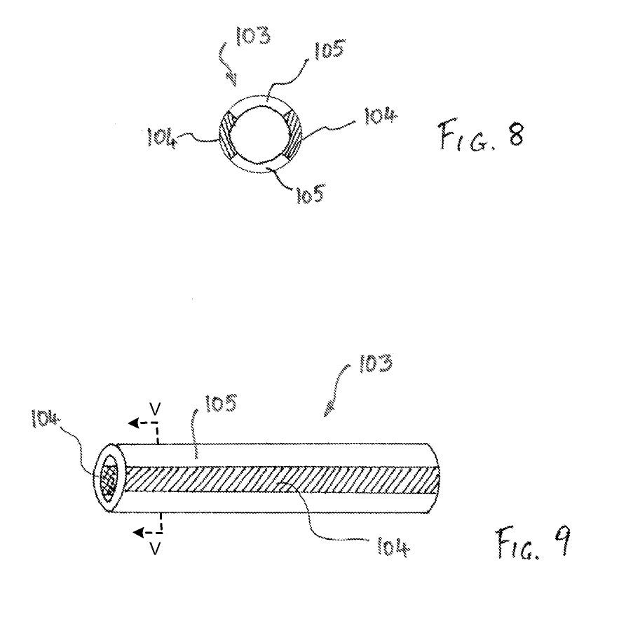

Alternatively, as seen in FIGS. 3 and 4, the conduit 3 can be provided with a circular cross-section which can either be constant or varying along its length.

As seen in FIG. 5, it will be apparent that the conduit 3 is in thermal contact with the thermally conductive disc 5 which is cold relative to the heat exchanger 17 and thermally conductive sleeve 16. As a consequence, the liquid (not illustrated) within the conduit 3 is subjected to a temperature difference which establishes a convective flow of the liquid through the conduit 3.

As seen in FIG. 6, the thermally conductive stem 6 preferably extends to the top of the cone shaped thermal conductor 2 and supports same. In addition, the thermally conductive stem 6 also supports of stack of annular permanent magnets 20 having polarities as indicated in the drawing. A plurality of conducting plates 21 are attached to thermally conductive stem 6 and separate each of the plurality of annular permanent magnets 20 in the stack.

The fluid confined within the conduit 3 contains small particles, each of which has a magnetic dipole. One form of such particles is powdered iron oxide, for example, magnetite. It will be apparent to those skilled in the art that the paramagnetic magnetite becomes magnetised with magnetic dipoles being created due to the magnetic fields created by the permanent magnets 21 so as to align the dipoles within the conduit 3. This alignment of the dipoles, together with the thermally induced motion of the liquid, means that the magnetic field of the dipoles is cutting the turns of the coil 13 (i.e., the magnetic field of the dipoles of the magnetite particles moves relative to the coils and exposes the coils to a varying magnetic field) and thereby generates (i.e., via induction) an emf in the coil 13 which registers as a voltage on the voltmeter 14. In this connection it will be observed that the path travelled by the magnetic dipoles is both curved and the radius of curvature of the curved path continuously changes.

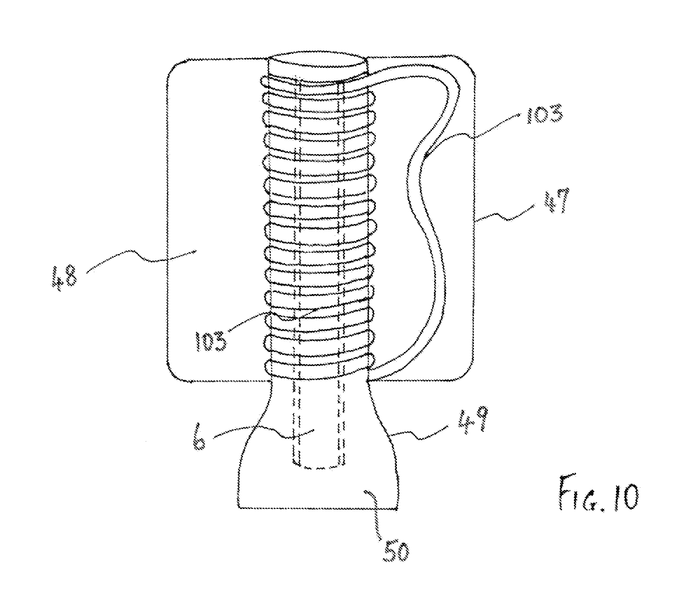

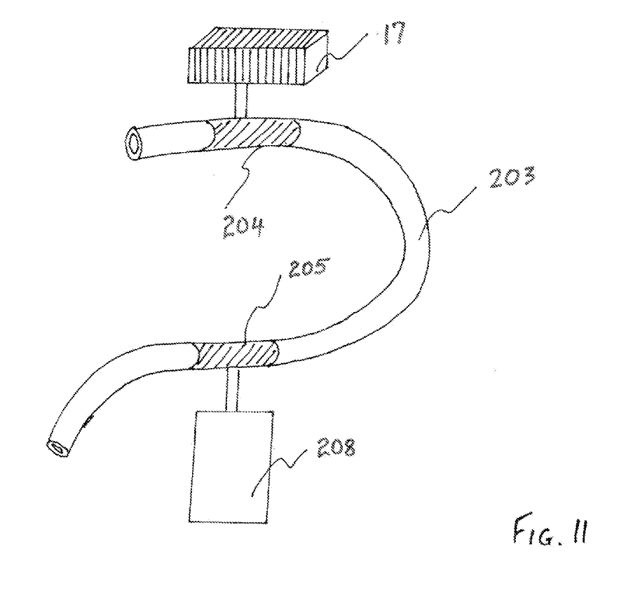

Turning now to FIGS. 8 and 9, an alternative conduit 103 is illustrated having two strips 104 of thermally and electrically conductive material such as copper interspaced with strips 105 of insulating material such as rubber or plastic. The conductive strips 104 maximise the transfer of heat into and from the conduit 103.

Turning now to FIG. 10, an alternative form of a transfer mechanism is illustrated in which a heat exchanger 47 confines a liquid 48 which is heated by solar radiation incident upon the heat exchanger 47. The return path of the conduit 103 lies within the heat exchanger 47. The thermally conductive stem 6 is surrounded by a cylindrical housing 49 upon which the conduit 103 is coiled and which contains a liquid 50 which is in thermal communication with the thermally conductive stem 6 and therefore the earth 8 (illustrated in FIG. 1).

In FIG. 11 an alternative heat exchanger arrangement for a conduit 203 is illustrated. The conduit 203 is not thermally conductive but has two thermally conductive portions 204, 205 which are respectively connected to the heat exchanger 17 and a heat sink 208 which can include a tank of water, for example, or the earth 8 as illustrated in FIG. 1. The two thermally conductive portions 204, 205 are constructed so as to have an internal surface which is flush with the internal surface of the conduit 203 so as to thereby ensure a smooth flow of the fluid having the magnetic dipoles.

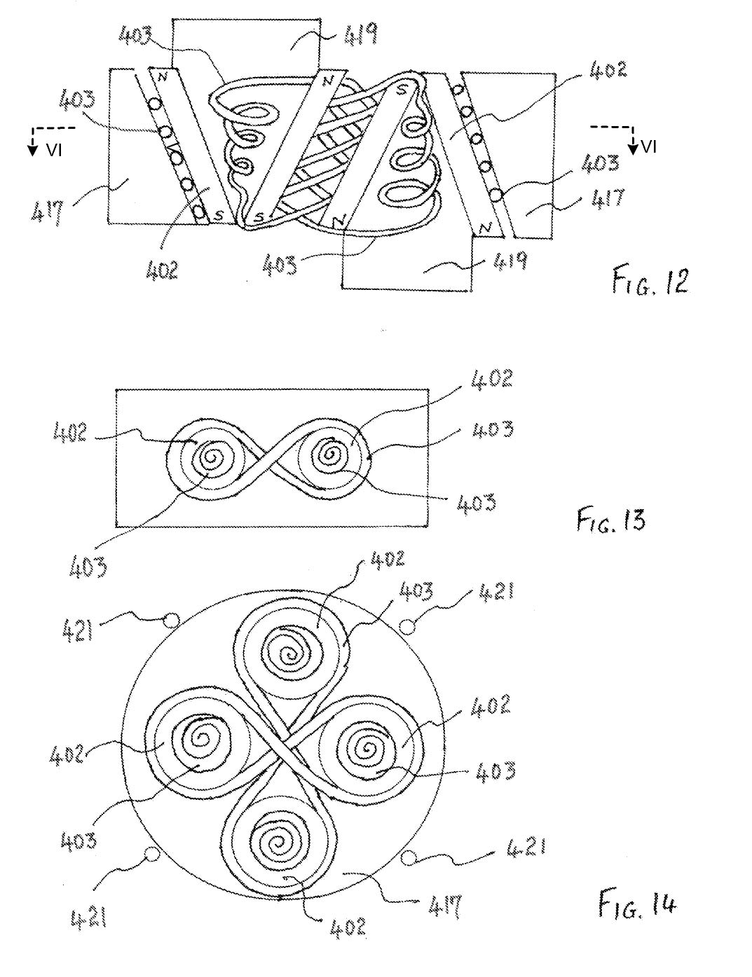

Turning now to FIGS. 12 and 13, a duplicated arrangement is illustrated with two heat sources 417 and two heat sinks 419. The heat sinks are in thermal communication with two cone shaped thermal conductors 402 each of which has a corresponding conduit 403. Each conduit 403 spirals through the interior of the cone shaped thermal conductors 402 and then passes between the heat sources 417 and the cone shaped thermal conductors 402.

Furthermore, as illustrated in FIG. 14, a four spiral arrangement generator is illustrated in which like parts to the arrangement illustrated in FIGS. 12 and 13 have the same designation numbers in FIG. 14. In FIG. 14 preferably additional magnets 421 are placed exterior to the heat source 417.

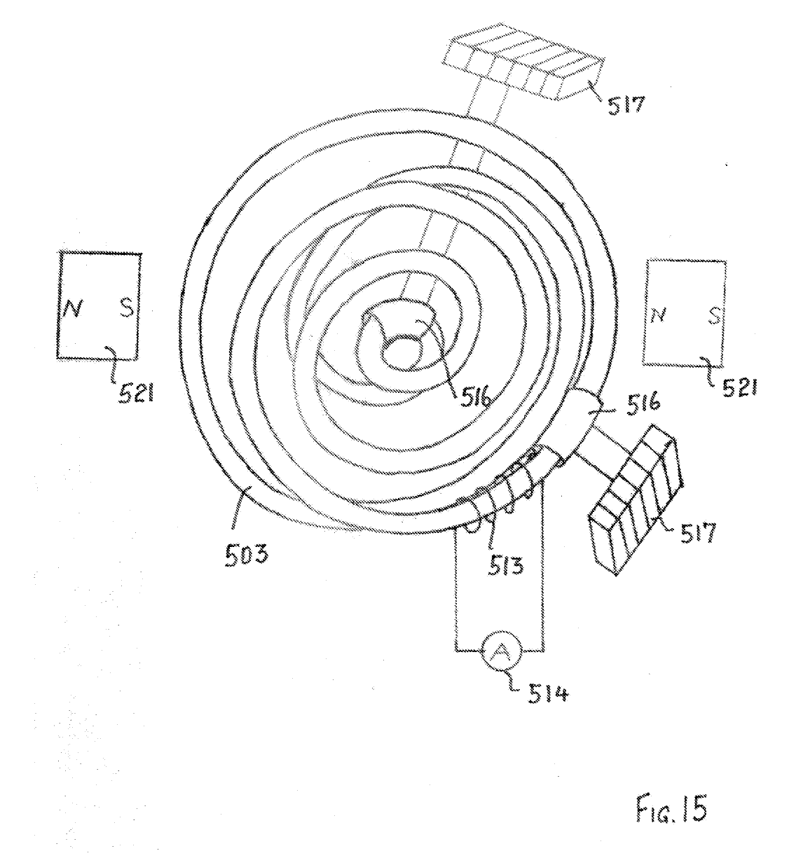

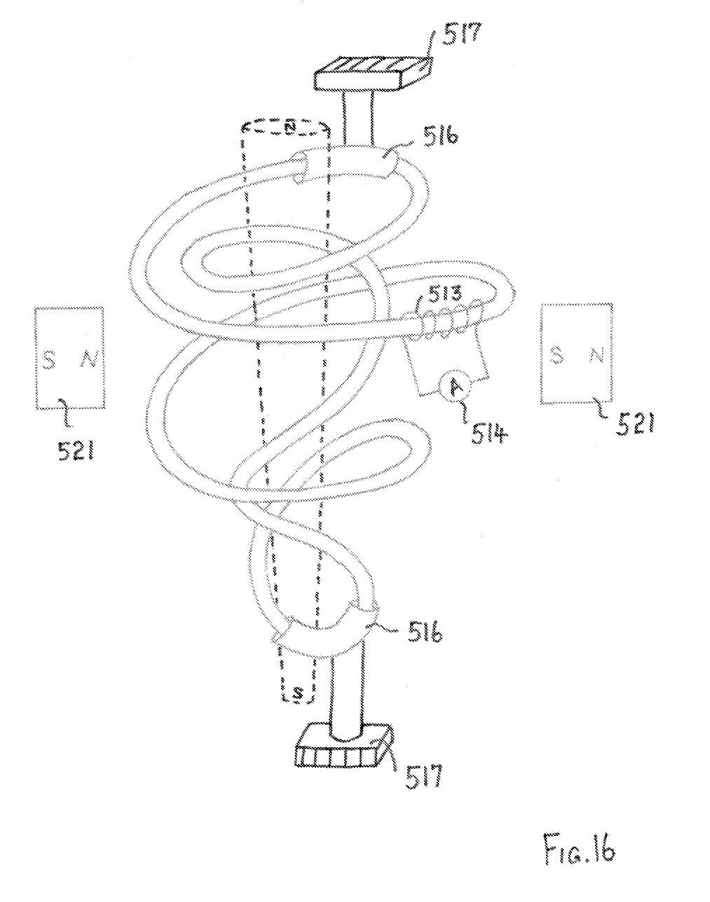

As seen in FIGS. 15 and 16 a conduit 503 having a generally spiral shape but a closed path extends vertically between a pair of horizontally spaced permanent magnets 521. Two sleeves 516 and two heat exchangers 517 enable a convective flow of liquid within the conduit 503 to be established. As before a coil 513 is wound on the conduit 503 and terminates in a meter 514.

The operation of the generator of FIGS. 15 and 16 is substantially the same as that described above save that the geometry of the conduit 503 is different from that of the conduit 3, 103, 203. In addition, instead of the magnets 521 giving a magnetic field with a generally horizontal alignment, a vertically aligned magnetic field as indicated by broken lines in FIG. 16 can be used.

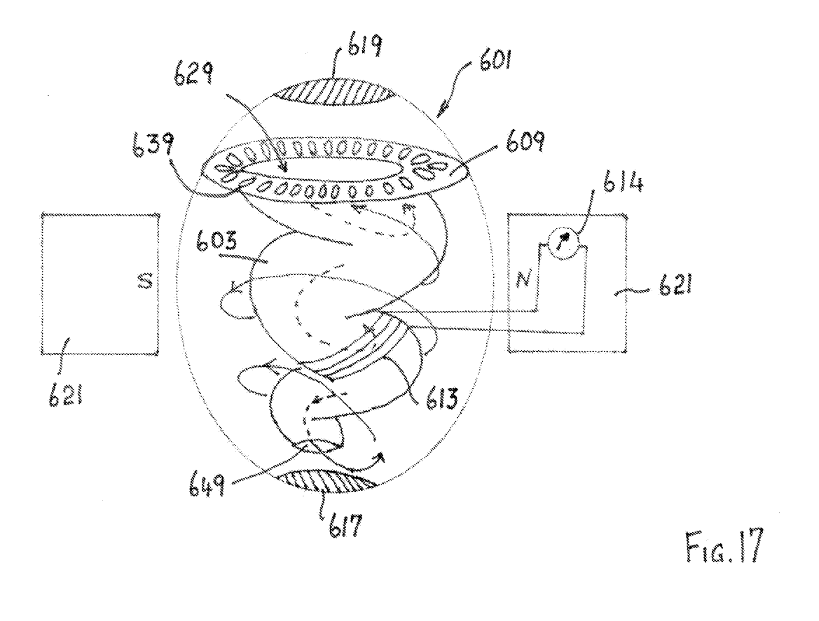

Turning now to FIG. 17, another embodiment is illustrated in which a hollow ovoid 601 contains the working liquid. An annular plate 609 is positioned near the top of the hollow ovoid 601 and has a central aperture 629 and a plurality of regularly spaced apart holes 639. The central aperture 629 is the upper opening of a generally vertically arranged gnomic spiral conduit 603 which has an exit aperture 649.

As before a coil 613 is wound on the conduit 603, terminates in a meter 614 and is located in a generally horizontal magnet field which extends between a pair of permanent magnets 621. Located at the bottom of the hollow ovoid 601 is a heat source 617 and located at the top of the ovoid is a heat sink 619. The difference in temperature between the heat source 617 and heat sink 619 sets up a convective flow. The upwards convective flow is illustrated by solid arrows in FIG. 17 and flows upwardly through the regularly spaced apart holes 639. Thereafter, the liquid cooled by the heat sink 619 falls into the central aperture 629 and thereafter spirals downwardly through the conduit 603 as indicated by broken line arrows in FIG. 17.

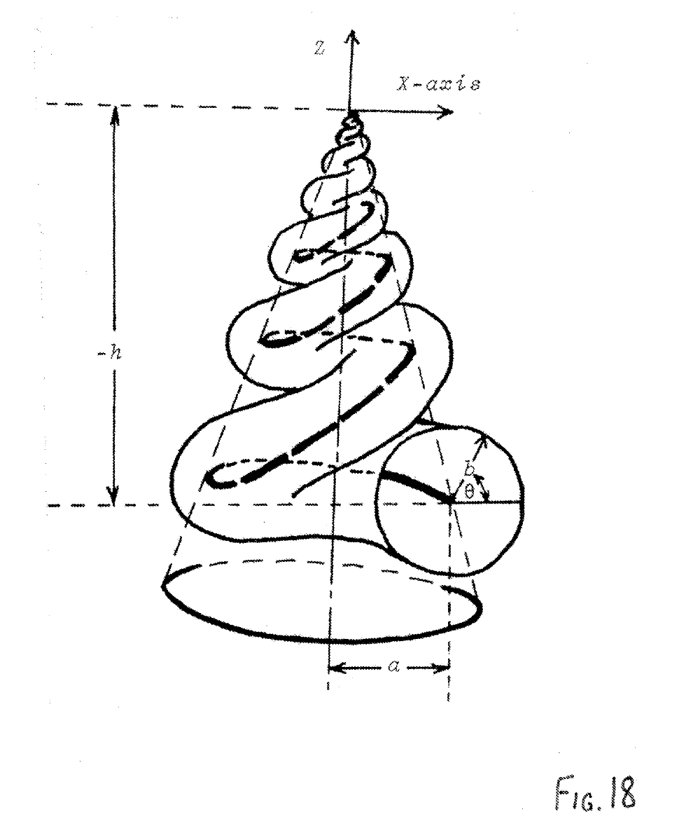

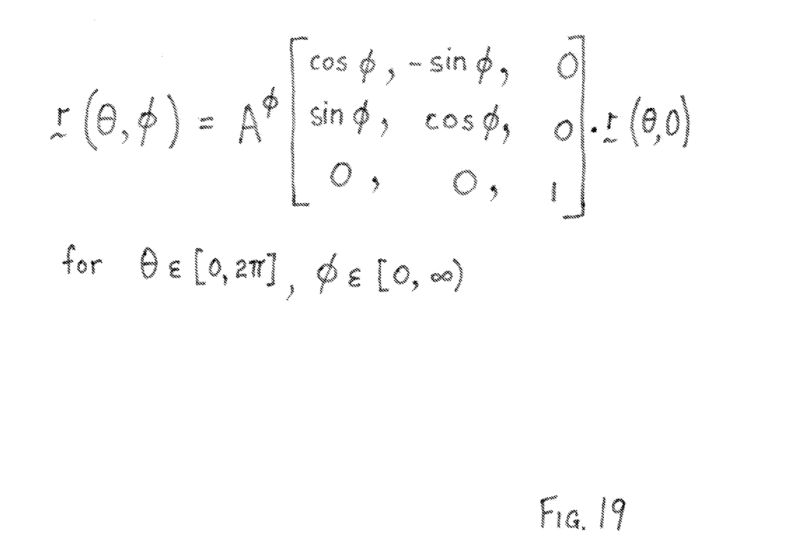

The conduit 603 is preferably a portion of a gnomic spiral known to mathematics and to biology in the formation of marine sea shells, for example. A typical form of such a gnomic spiral is illustrated in FIG. 18. A mathematical formula for a gnomic surface is given in FIG. 19. Useful surfaces are generated where the constant A is greater than zero but less than 1. The vector r(θ,0) is the shape of the generating curve which is assumed to lie in the X-Z plane whilst the matrix corresponds to a simple rotation through the angle φ measured about the Z axis. The conduit 603 of FIG. 17 is a truncated and inverted form of the spiral illustrated in FIG. 18.

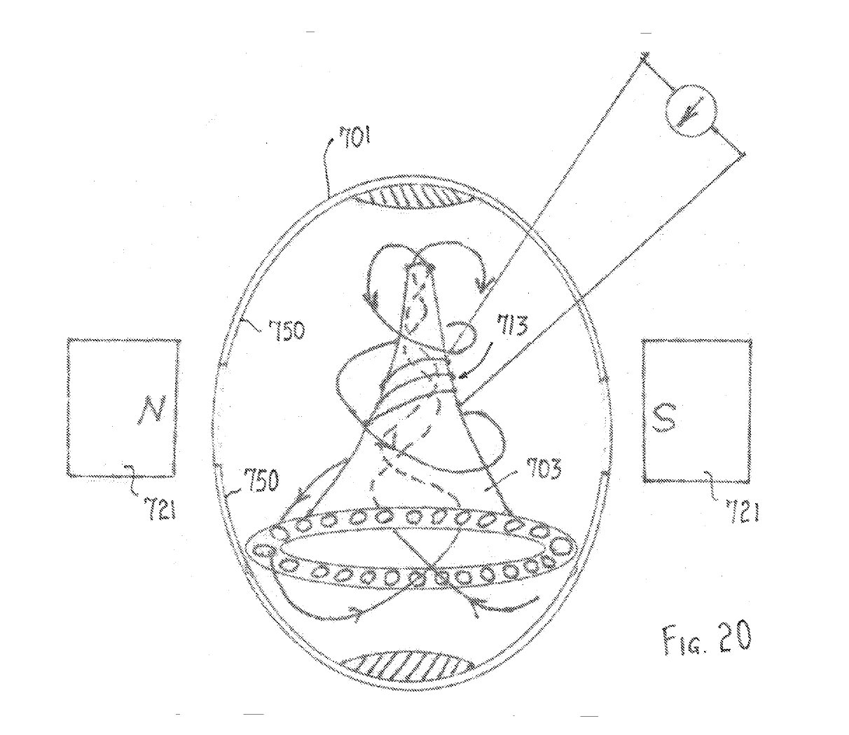

FIG. 20 illustrates yet another generator similar to that of FIG. 17 save that the hollow ovoid 701 has an interior lining 750 of diamagnetic bismuth (except opposite the magnets 721) and the conduit 703 has an elliptical horn shape about which the coil 713 is wound. The fluid moves in curved paths indicated by the arrows in FIG. 20.

It will be apparent to those skilled in the art that the generators of FIG. 17 can be inverted and the roles of the heat source and heat sink reversed, in which case the upwards convective flow through the conduit 603 is indicated by broken arrows in the inverted FIG. 17.

To summarise, disclosed are a number of preferred features and concepts for generating electricity in accordance with embodiments of the present invention, including: 1) a temperature differential to drive via convective flow a fluid comprised of particles which have magnetised magnetic dipoles coated with a surfactant and suspended in a carrier fluid or a paramagnetic fluid comprised of particles which have dipoles that become magnetic under the influence of an external magnetic field; 2) a vessel (or conduit in some of the embodiments) comprised of any continuously-varying curved surface to influence the flow and acceleration of the particles of the fluid (the surface is a conduit in some embodiments and a continuously curved shape in others that facilitates the helicoidal movement of the fluid); 3) a coil to, in response to the flow of the particles of the fluid, generate an emf in an external circuit; 4) a magnetic field comprised of the earth's magnetic field and/or an auxiliary magnetic field preferably created by at least one pair of magnetic poles placed in vicinity of apparatus; and 5) a diamagnetic material used on surfaces near flowing fluid or in fluid.

The foregoing describes only some embodiments of the present invention and modifications, obvious to those skilled in the electric generator arts, can be made thereto without departing from the scope of the present invention.

For example, the heat exchanger 17 can constitute a conventional solar hot water heater. Similarly, instead of magnetite, the ferrofluid can contain or comprise paramagnetic iron chloride or iron sulphate.

The term “comprising” (and its grammatical variations) as used herein is used in the inclusive sense of “including” or “having” and not in the exclusive sense of “consisting only of”.

1. A method of generating electricity, said method comprising the steps of:
confining a liquid including particles having a magnetic dipole to a conduit formed into an endless loop;
winding a coil around at least a portion of said conduit;
exposing said conduit to a temperature difference to establish a convective flow in said liquid through said conduit; and
exposing said liquid to a first magnetic field to align said particles whilst within said first magnetic field, wherein a second magnetic field produced by said aligned dipoles moves relative to said coil to thereby generate an emf therein.

2. The method of claim 1 wherein said exposing step comprises exposing at least part of said conduit to solar radiation or placing at least part of said conduit in thermal contact with a body heated by solar radiation.

3. The method of claim 1 further comprising the step of forming said conduit into at least one substantially conical or gnomic spiral.

4. The method of claim 1 further comprising the step of alternating the direction of said first magnetic field.

5. The method of claim 4 further comprising the step of generating said first magnetic field by a stack of permanent magnets having alternating polarities.

6. The method of claim 1 further comprising the step of forming said particles from particles of an oxide, chloride or sulphate of iron.

7. An apparatus for generating electricity, said apparatus comprising:
a conduit formed into an endless loop and confining a liquid including particles having a magnetic dipole;
a coil wound around at least a portion of said conduit;
heat transfer means connected with said conduit to establish a temperature difference in said conduit which establishes a convective flow in said liquid through said conduit; and
a pair of magnetic poles between which extends a first magnetic field to which said liquid is exposed to align magnetic dipoles of said particles whilst within said first magnetic field, whereby a second magnetic field produced by said aligned magnetic dipoles of said particles moves relative to said coil to thereby generate an emf therein.

8. The apparatus of claim 7 wherein said heat transfer means comprises a heat exchanger.

9. The apparatus of claim 8 wherein said heat exchanger is heated by solar radiation.

10. The apparatus of claim 7 wherein said conduit is formed into at least one substantially conical or gnomic spiral.

11. The apparatus of claim 7 wherein said pair of magnetic poles comprise one of a plurality of magnetic poles of alternating polarity.

12. The apparatus of claim 11 wherein said plurality of magnetic poles comprise a stack of permanent magnets having alternating polarities.

13. The apparatus of claim 7 wherein said particles are formed from particles of an oxide, chloride or sulphate of iron.
